(19) United States
(12) Patent Application Publication
(10) Pub. No.: US 2022/0388337 A1
(43) Pub. Date: Dec. 8, 2022

(54) BALL WHEEL, ASSEMBLY AND METHOD OF USE

(71) Applicant: Vinc L. Aulick, Scottsbluff, NE (US)

(72) Inventor: Vinc L. Aulick, Scottsbluff, NE (US)

(21) Appl. No.: 17/522,640

(22) Filed: Nov. 9, 2021

Related U.S. Application Data
(63) Continuation-in-part of application No. 29/786,725, filed on Jun. 2, 2021.

(51) Int. Cl. B60B 33/00; B60B 33/08; B60B 33/04; B60B 19/00

(52) U.S. Cl. CPC B60B 33/0036; B60B 33/08; B60B 33/045; B60B 19/003; B60B 2900/551; B60B 2360/50; B60B 2360/102; B60B 2200/24; B60B 2200/43; B60B 2200/45; B62B 2301/044; B62B 2301/20

(57) ABSTRACT

The present disclosure relates in general to a ball wheel, assembly and method of use for providing omni-directional rolling support to an article of manufacture such as, e.g., mechanics creepers, crates, carts, dollies, stretchers, gurneys, litters, beds, prams, transports, and luggage. One aspect of the present disclosure includes a ball wheel for a ball wheel assembly. The ball wheel comprises a roughly spherical shaped body having a plurality of features on an exterior surface of the body configured to assist the ball wheel in overcoming obstacles/debris in the surrounding environment and being used on uneven surfaces. Another aspect of the present disclosure includes a ball wheel assembly comprising the ball wheel. The ball wheel assembly may include a housing with an interior socket and shock absorber that allows the ball wheel to rotate therein while providing a cushioning effect. A still further aspect of the present disclosure includes a plurality of ball wheel assemblies mounted on an article of manufacture. Yet another aspect of the present disclosure is a method of using the ball wheel assembly on an article of manufacture. An intended purpose of the present disclosure is to provide a ball wheel and assembly for an article of manufacture that is designed to overcome obstacles/debris in the surrounding environment and being used on uneven surfaces via the combination of the cushioning effect of the shock absorber and the plurality of features of the ball wheel.

### CROSS REFERENCE TO RELATED APPLICATIONS

This application is a Continuation-in-Part of U.S. patent application Ser. No. 29/786,725 filed Jun. 2, 2021, herein incorporated by reference in its entirety.

### FIELD OF THE INVENTION

The present disclosure relates to a ball wheel, assembly and method of use. More specifically, the purpose of the invention is to provide a ball wheel, assembly and method of use that provides omni-directional rolling support to an article of manufacture. The ball wheel, assembly and method of use is configured such that the ball wheel is capable of being used on uneven surfaces and overcoming obstacles/debris in the surrounding environment. Applications of the ball wheel, assembly and method of the present disclosure may include incorporation into articles of manufacture across a variety of industries such as, e.g., mechanics creepers, crates, carts, dollies, stretchers, gurneys, litters, beds, prams, transports, and luggage.

### BACKGROUND OF THE INVENTION

Caster wheels are traditionally used to provide rolling support to articles of manufacture. Caster wheels include the wheel and the mounting assembly that holds the wheel in position. Some caster wheels may include a fixed mounting assembly. An article of manufacture mounted on a set of fixed caster wheels will only roll in a straight line. Other caster wheels, or swivel casters, may include a rotating mounting assembly which permits the wheel to spin in a complete circle perpendicular to the rotation of the wheel's axis. An article of manufacture mounted on a set of swivel casters may be omni-directional, or pushed in any direction. In most applications caster wheels are installed onto articles of manufacture in sets of two and four. If four caster wheels are utilized, typically, the two front casters remain fixed while the two rear casters swivel to achieve optimal stability and maneuverability for the article of manufacture during use.

Other types of wheels may also provide omni-directional rolling support, such as omni wheels and mecanum wheels. Omni wheels are configured to roll forward like a normal wheel, but also incorporate small rubber rollers on the edges of the wheel that move completely perpendicular to the wheel itself. In this manner the omni wheel is permitted to move forwards, backwards, and sideways with little friction. On the other hand mecanum wheels include a series of small external rollers obliquely attached to the entire circumference of the wheel rim at a 45° angle. This allows the mecanum wheel to be mounted like a normal wheel and yet glide laterally to provide omni-directional movement similar to the omni wheel.

While the current examples of omni-directional wheels as set forth above conveniently provide movement in any direction to an article of manufacture, however, significant problems remain. The biggest disadvantage, for instance, is that such wheels may only be utilized on a smooth flat surface. Forward, rearward and lateral movement is commonly interrupted by obstacles, debris and uneven surfaces in the surrounding environment as the wheel is unable to overcome such obstacles. Additional problems frequently associated with omni wheels and mecanum wheels in particular are their high costs to manufacture, difficulty to repair, substantial weight, and short life expectancy. Consequently, there is a growing demand to provide a more capable, reliable and inexpensive omni-directional wheel that may be used across a variety of industries.

For these reasons a desire remains to provide a rugged ball wheel, assembly and method of use that provides omni-directional rolling support capable of being used on uneven surfaces and overcoming obstacles/debris in the surrounding environment. What is further needed is a ball wheel, assembly and method of use that is inexpensive to manufacture, easy to repair, and comprised of lightweight and durable materials.

### SUMMARY OF THE INVENTION

According to one aspect of the present disclosure, a ball wheel for a ball wheel assembly is provided. The ball wheel may comprise a roughly spherical shaped body having a plurality of features configured to assist the ball wheel in overcoming obstacles/debris in the surrounding environment and being used on uneven surfaces. In particular, the plurality of features may comprise a plurality of raised knobs spaced equidistant apart on an exterior surface of the body. Each knob of the plurality of raised knobs for the ball wheel may include an interior socket having a ball opening with a ball inserted therein. The ball may be of a type commonly utilized with ball bearings formed of solid material such as stainless steel, chrome steel, ceramic or plastic. A portion of the ball may extend through the ball opening and outside the socket. The socket inside the knob forms a ball-and-socket joint with the ball. The ball-and-socket joint is configured to secure the ball inside the socket such that the ball does not fall out of the socket during operation of the ball wheel and ball wheel assembly.

According to an alternative aspect of the ball wheel of the present disclosure, the plurality of features configured to assist the ball wheel in overcoming obstacles/debris in the surrounding environment and being used on uneven surfaces may comprise a plurality of dimples spaced equidistant apart on the exterior surface of the body. Each dimple may comprise a circular bowl-shaped depression. Alternatively, each dimple may comprise a hexagonal bowl-shaped depression. It is contemplated by the present disclosure that other types of bowl-shaped depressions may also be utilized, e.g., oval, triangular, square, pentagonal, octagonal, among others.

According to another aspect of the present disclosure, a ball wheel assembly comprising the ball wheel is provided. The ball wheel assembly may include a housing having an interior socket and a ball wheel opening with the ball wheel inserted therein. A portion of the ball wheel may extend through the ball wheel opening and outside the socket. The socket inside the housing forms a ball-and-socket joint with the ball wheel. The ball-and-socket joint is configured to secure the ball wheel inside the socket wherein the ball wheel is rotatable inside the socket. The housing may further include a retaining lip for retaining the ball wheel inside the socket of the housing such that the ball wheel does not fall out of the socket during operation of the ball wheel assembly. The ball wheel assembly may also include a shock absorber positioned inside the housing and adapted to provide a cushioning effect to the ball wheel inside the socket during operation.

According to a further aspect of the present disclosure, a plurality of ball wheel assemblies mounted on an article of manufacture is provided. The article of manufacture may comprise, e.g., mechanics creepers, crates, carts, dollies, stretchers, gurneys, litters, beds, prams, transports, luggage, and other types of load carrying devices that require mobility. In particular, the plurality of ball wheel assemblies may be mounted on an underside of the article of manufacture to provide omni-directional rolling support using permanent or removable means of attachment. The plurality of ball wheel assemblies allow the article of manufacture to be capable of being used on uneven surfaces and overcoming obstacles/debris in the surrounding environment via the combination of the cushioning effect of the shock absorber and the balls and raised knobs, or alternatively the plurality of dimples, of the ball wheel.

Another aspect of the present disclosure is a method of using the ball wheel assembly on an article of manufacture. In particular, the method may comprise providing an article of manufacture that requires omni-directional rolling support, such as a mechanics creeper, crate, cart, dolly, stretcher, gurney, litter, bed, pram, transport, luggage, or other types of load carrying devices that require mobility. The method may further include providing at least two ball wheel assemblies and incorporating the at least two ball wheel assemblies into an underside of the article of manufacture. The method may further include providing omni-directional rolling support to the article of manufacture via the at least two ball wheel assemblies.

### PRINCIPAL OBJECTS AND ADVANTAGES OF THE INVENTION

Therefore, it is a principal object, feature, and/or advantage of the present disclosure to overcome the aforementioned deficiencies in the art and provide a ball wheel, assembly and method of use that provides omni-directional rolling support to an article of manufacture.

Another object, feature, and/or advantage of the present disclosure is to provide a rugged ball wheel, assembly and method of use that is configured such that the ball wheel may overcome obstacles/debris in the surrounding environment and is capable of being used on uneven surfaces.

Yet another object, feature, and/or advantage of the present disclosure is to provide a ball wheel, assembly and method of use that may be incorporated into articles of manufacture across a variety of industries such as, e.g., mechanics creepers, crates, carts, dollies, stretchers, gurneys, litters, beds, prams, transports, and luggage.

A further object, feature, and/or advantage of the present disclosure is to provide a ball wheel, assembly and method of use that is inexpensive to manufacture, easy to repair, and comprised of lightweight and durable materials.

Other objects, features, and advantages of this disclosure will become apparent from the following description taken in conjunction with the accompanying drawing wherein are set forth, by way of illustration and example and without limitation, certain aspects of this disclosure. The present disclosure is not to be limited to or by these objects, features, and advantages. No single aspect need provide each and every object, feature, or advantage.

### BRIEF DESCRIPTION OF THE DRAWINGS

FIGS. 1-9 represent aspects of the ball wheel, assembly and method of the present disclosure.

FIG. 1 is a perspective view of one aspect of the present disclosure showing a ball wheel.

FIG. 1A is a cross-sectional view of a ball-and-socket joint of the ball wheel of FIG. 1.

FIG. 2 is a top plan view of the ball wheel of FIG. 1, the bottom plan view being identical.

FIG. 3 is a front-side elevational view of the ball wheel of FIG. 1, the rear-side elevational view, the right-side elevational view and the left-side elevational view being identical.

FIG. 4 is a top plan view of another aspect of the ball wheel, the bottom plan view, front-side elevational view, the rear-side elevational view, the right-side elevational view and the left-side elevational view being identical.

FIG. 5 is a top plan view of yet another aspect of the ball wheel, the bottom plan view, front-side elevational view, the rear-side elevational view, the right-side elevational view and the left-side elevational view being identical.

FIG. 6 is a perspective view of a further aspect of the present disclosure showing a ball wheel assembly.

FIG. 7 is cross-sectional view of the ball wheel assembly of FIG. 6 taken along line 5-5.

FIG. 8 is an exploded view of the ball wheel assembly of FIG. 6.

FIG. 9 is a perspective view of another aspect of the present disclosure showing a plurality of ball wheel assemblies mounted on an article of manufacture.

### DETAILED DESCRIPTION OF THE INVENTION

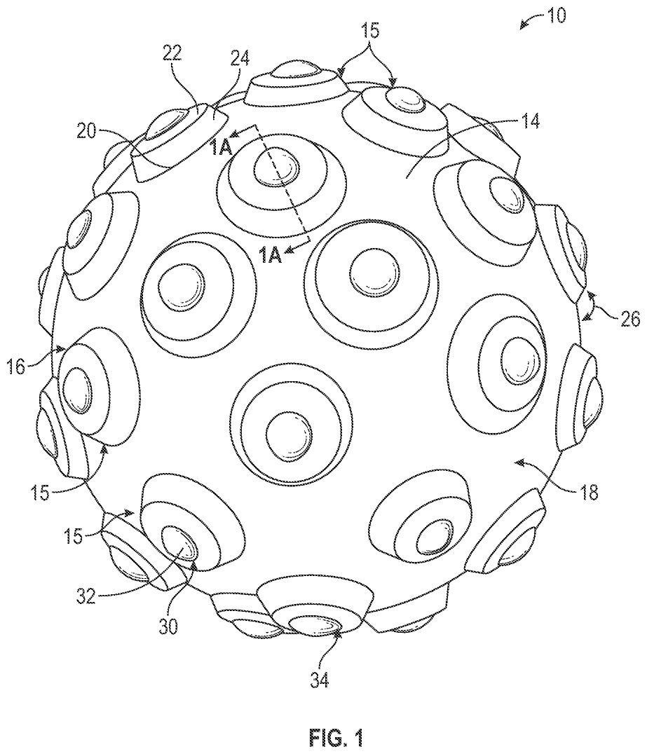

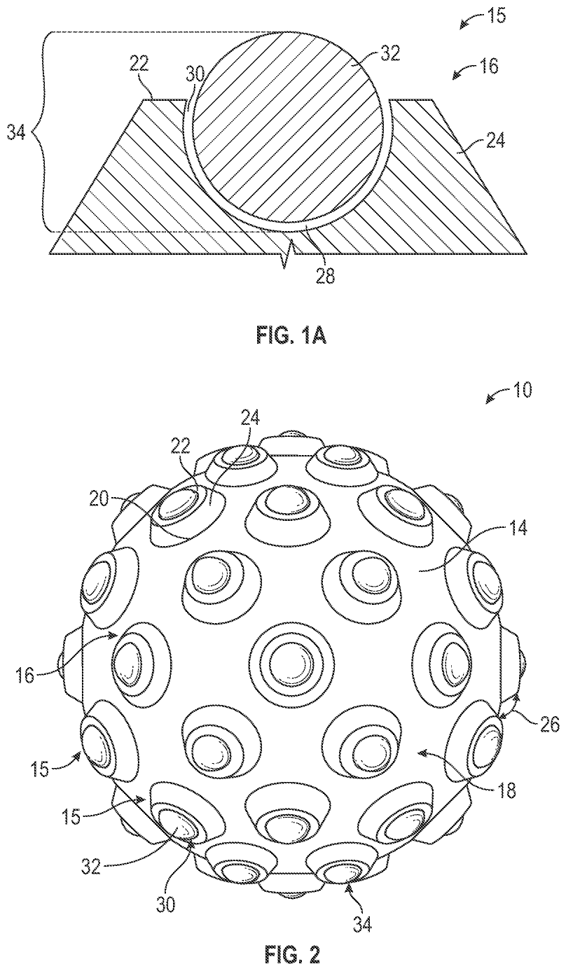

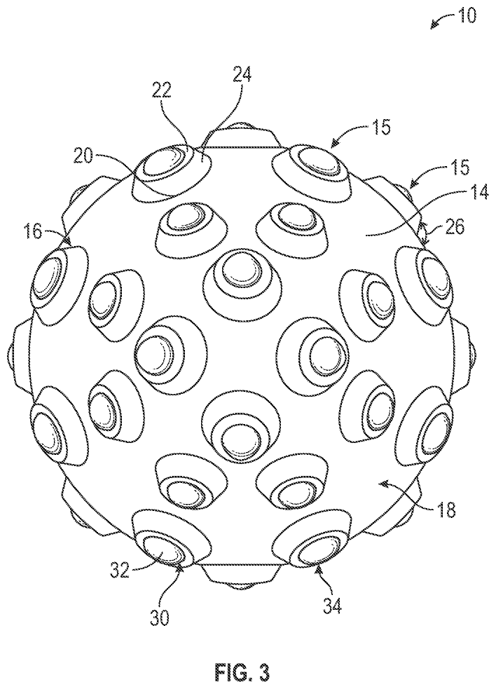

Referring generally to FIGS. 1-9, the present disclosure is directed towards a ball wheel, assembly and a method of use. It is contemplated that the ball wheel, assembly and method of the present disclosure may be incorporated into articles of manufacture across a variety of industries. Non-limiting examples of articles of manufacture contemplated by the present disclosure may include mechanics creepers, crates, carts, dollies, stretchers, gurneys, litters, beds, prams, transports, and luggage. It is further contemplated that the ball wheel, assembly and method of the present disclosure may be capable of being used on uneven surfaces and overcoming obstacles/debris in the surrounding environment. The ball wheel, assembly and method of use of the present disclosure is designed to be inexpensive to manufacture, easy to repair, and comprised of lightweight and durable materials.

While certain aspects of the present disclosure are shown and described herein, it is understood that such aspects are merely exemplary. The present disclosure is not intended to be limited to these specific aspects and may encompass other aspects or embodiments. Therefore, specific compositional and process details disclosed herein are not to be interpreted or inferred as limiting, but merely as a basis for the claims and as a representative basis for teaching one skilled in the art how to make and use the disclosed subject matter.

It must further be noted that the singular terms “a,” “an,” and “the” as used herein may include plural referents unless the context clearly dictates otherwise. As used herein, in particular aspects, the terms “about” or “approximately” when preceding a numerical value indicates the value plus or minus a range of 0.2, 0.4, 0.6, 0.8 or 1 inch. In other aspects, the terms “about” or “approximately” when preceding a numerical value indicates the value plus or minus a range of 2, 3, 4 or 5 inches. In yet other aspects, the terms “about” or “approximately” when preceding a numerical value indicates the value plus or minus a range of 6, 7, 8, 9 or 10 inches. Furthermore the transitional phrase “comprising” that is synonymous with “including,” “containing,” and “characterized by” as used herein is inclusive or open-ended and does not exclude additional, unrecited elements, steps or ingredients. Alternatively the transitional phrase “consisting of” as used herein is closed and excludes any element, step or ingredient not specified.

FIGS. 1-3 illustrate one aspect of the present disclosure, in particular, a ball wheel 10 for a ball wheel assembly 12. The ball wheel 10 may comprise a roughly spherical shaped body 14 having a hollow core, or alternatively, a solid core. The overall size of the ball wheel 10 may range from having a diameter of approximately 1 inch to approximately 1 foot, depending on the intended purpose for the ball wheel assembly 12. The ball wheel 10 may further comprise a plurality of features 15 configured to assist the ball wheel 10 in overcoming obstacles/debris in the surrounding environment and being used on uneven surfaces. In particular, the plurality of features 15 may comprise a plurality of raised knobs 16 spaced equidistant apart on an exterior surface 18 of the body 14. Each knob 16 of the plurality of raised knobs 16 may comprise a uniform pyramidal shape having a circular base 20, a flat top 22 and angled side walls 24. The angled side walls 24 may form an obtuse angle 26 with the body 14, e.g., greater than 90° to less than 180°. The plurality of raised knobs 16 may alternatively comprise other shapes including but not limited to round, square, or triangular shaped protuberances (not shown). The body 14 and the plurality of raised knobs 16 of the ball wheel 10 may be formed of injected molded rubber comprising, e.g., carbon fiber reinforced polymers and/or high strength plastics configured to provide flexible rigidity and long-lasting durability to the ball wheel 10. The plurality of raised knobs 16 may be integrally formed with the body 14 or alternatively separately formed and subsequently attached to the body 14 using adhesives, plastic welds or other permanent fastening means.

Further shown in FIG. 1A, each knob 16 of the plurality of raised knobs 16 for the ball wheel 10 may include an interior socket 28 having a ball opening 30 with a ball 32 inserted therein. In particular, a portion of the ball 32, e.g., between approximately ⅛ to ½ of the diameter of the ball 32, may extend through the ball opening 30 and outside the socket 28. The ball opening 30 may reside in the center of the flat top 22 of the raised knob 16. The socket 28 may be integrally formed within the knob 16 to form a ball-and-socket joint 34 with the ball 32. The ball-and-socket joint 34 may be configured to snugly secure the ball 32 inside the socket 28 wherein the ball 32 does not rotate. Alternatively, the ball-and-socket joint 34 may be configured to snugly secure the ball 32 inside the socket 28 wherein the ball 32 is rotatable inside the socket 28. In either example, the ball-and-socket joint 34 is configured to secure the ball 32 inside the socket 28 such that the ball 32 does not fall out of the socket 28 during operation of the ball wheel 10 and ball wheel assembly 12. The ball 32 may be of a type commonly utilized with ball bearings formed of solid material such as stainless steel, chrome steel, ceramic or plastic and have a diameter of between approximately 1.5 mm-25.4 mm.

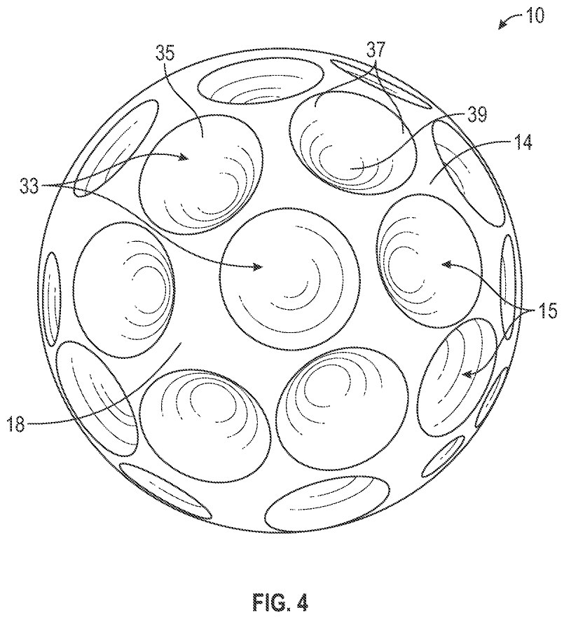

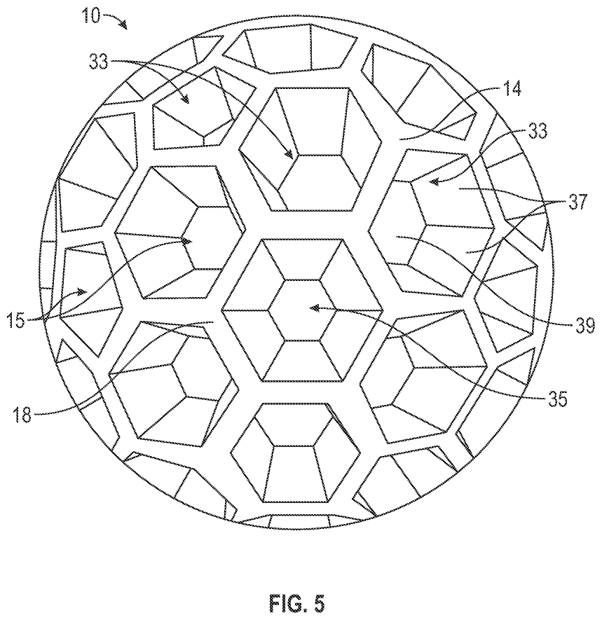

FIGS. 4-5 illustrate alternative aspects of the ball wheel 10 of the present disclosure. In particular, the ball wheel 10 may comprise a roughly spherical shaped body 14 having a hollow core, or alternatively, a solid core. The overall size of the ball wheel 10 may range from having a diameter of approximately 1 inch to approximately 1 foot, depending on the intended purpose for the ball wheel assembly 12. The ball wheel 10 may further comprise a plurality of features 15 configured to assist the ball wheel 10 in overcoming obstacles/debris in the surrounding environment and being used on uneven surfaces. In particular, the plurality of features 15 may comprise a plurality of dimples 33 spaced equidistant apart on the exterior surface 18 of the body 14. The body 14 and the plurality of dimples 33 of the ball wheel 10 may be integrally formed of injected molded rubber comprising, e.g., carbon fiber reinforced polymers and/or high strength plastics configured to provide flexible rigidity and long-lasting durability to the ball wheel 10.

Shown in FIGS. 4-5, each dimple 33 of the plurality of dimples 33 may comprise a bowl-shaped depression 35 having a plurality of side walls 37 and a base 39. Specifically, each dimple 33 may be approximately 0.120-0.425 inch in diameter and approximately 0.125-0.250 inch in depth. In another aspect each dimple 33 may be approximately 0.120-1 inch in diameter and approximately 0.125-0.5 inch in depth. The plurality of dimples 33 are configured to take up approximately 60-95% of the exterior surface 18 of the body 14. The plurality of dimples 33 illustrated in FIGS. 4-5 are depicted as being uniform in shape and appearance on the exterior surface 18 of the body 14 of the ball wheel 10. However, it is also contemplated by the present disclosure that varying shapes and appearances of dimples 33 may be combined together and utilized on the exterior surface 18 of the body 14 of the ball wheel 10.

Shown in FIG. 4, one aspect of the ball wheel 10 may include a plurality of dimples 33 each comprising a circular bowl-shaped depression 35. Shown in FIG. 5, an alternative aspect of the ball wheel 10 may include a plurality of dimples 33 each comprising a hexagonal bowl-shaped depression 35. Other types of bowl-shaped depressions 35 may also be utilized by the present disclosure, including but not limited to, oval, triangular, square, pentagonal, and octagonal bowl-shaped depressions 35 (not shown).

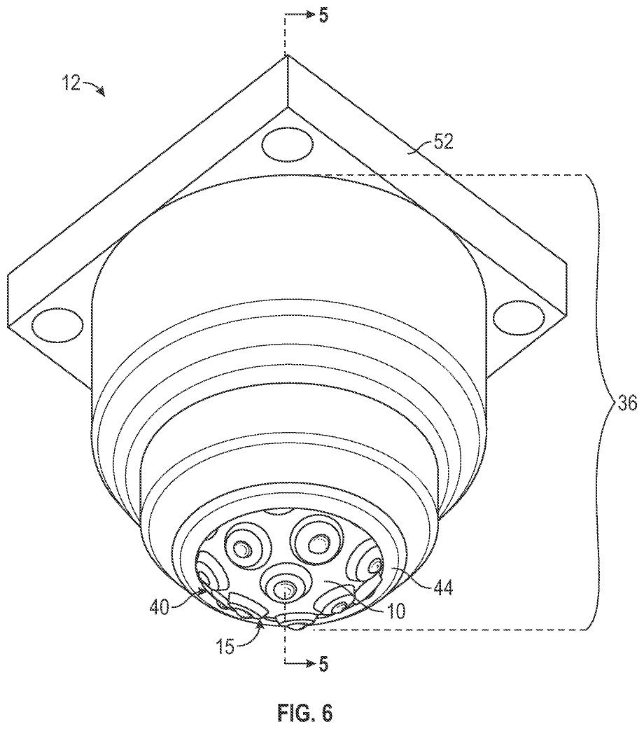

FIGS. 6-8 illustrate yet another aspect of the present disclosure, in particular, the ball wheel assembly 12 comprising the ball wheel 10. The ball wheel assembly 12 may include a housing 36 formed of rigid material(s) such as, e.g., plastics, metals, aluminum, or composites. The housing 36 may include an interior socket 38 having a ball wheel opening 40 with the ball wheel 10 inserted therein. In particular, a portion of the ball wheel 10, e.g., between approximately ⅛ to ½ of the diameter of the ball wheel 10, may extend through the ball wheel opening 40 and outside the socket 38. The socket 38 may be integrally formed within the housing 36 to form a ball-and-socket joint 42 with the ball wheel 10. The ball-and-socket joint 42 may be configured to snugly secure the ball wheel 10 inside the socket 38 wherein the ball wheel 10 is rotatable inside the socket 38. The housing 36 may further comprise a retaining lip 44 configured to retain the ball wheel 10 inside the socket 38 of the housing 36 such that the ball wheel 10 does not fall out of the socket 38 during operation of the ball wheel 10 and ball wheel assembly 12. The overall size of the ball wheel assembly 12 may be scalable to fit a correspondingly sized ball wheel 10 inside the socket 38 of the housing 36, depending on the intended purpose for the ball wheel assembly 12.

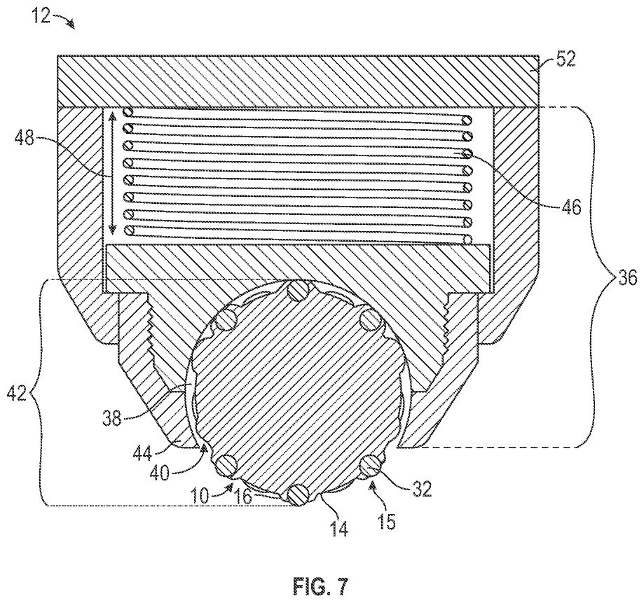

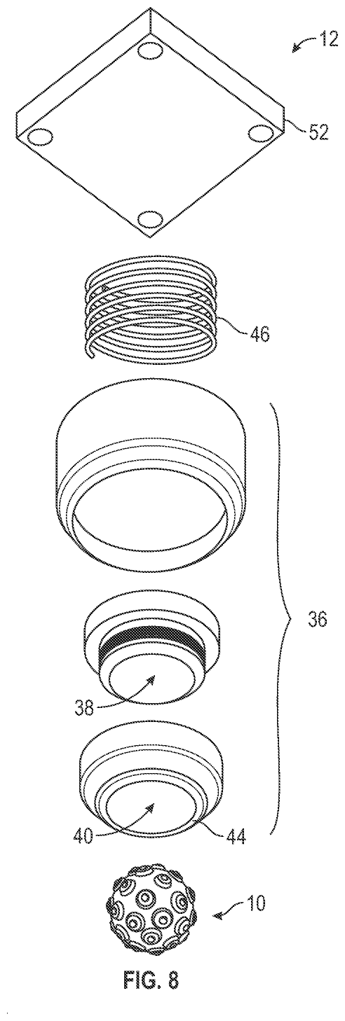

Shown in FIGS. 7-8, the ball wheel assembly 12 may further comprise a shock absorber 46 positioned inside the housing 36. The shock absorber 46 may be adapted to provide opposing forces 48 that deliver a cushioning effect to the ball wheel 10 inside the socket 38 as weight is applied during operation of the ball wheel assembly 12. For example, the shock absorber 46 may be configured to allow the ball wheel 10 to vertically adjust inside the socket 38 approximately ¼-1 inch as the ball wheel 10 rolls over obstacles/debris or weight is applied to the housing 36 during operation. The shock absorber 46 may also be adapted to provide opposing forces 48 to the ball wheel 10 to maintain at least a portion of the ball wheel 10 extending through the ball wheel opening 40 and outside the socket 38. In this manner, the ball wheel assembly 12 is configured such that the ball wheel 10 may roll up and over obstacles/debris (e.g., pebbles, lock washers, air hoses, tools, cracks in pavement) in the surrounding environment and is thus designed for use on uneven surfaces via the combination of the cushioning effect of the shock absorber 46 and the plurality of features 15 (e.g., balls 32 and raised knobs 16, or alternatively, the plurality of dimples 33) of the ball wheel 10. While the shock absorber 46 is depicted in FIGS. 7-8 as a helically coiled compression spring, it is contemplated by the present disclosure that other types of shock absorbers 46 may also be utilized such as, e.g., foam cushions, air springs, gas springs, and hydraulic springs. It is further contemplated by the present disclosure that varying spring strengths may be utilized depending on the intended use of the ball wheel assembly 12 and maximum weight involved with such use, wherein the shock absorbers 46 are configured to be exchangeable within the housing 36.

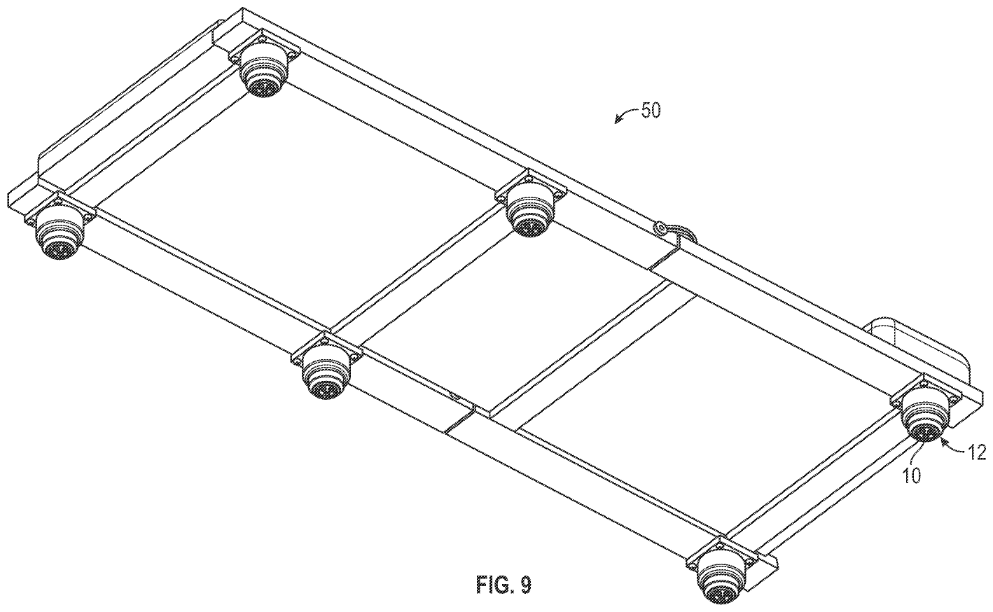

FIG. 9 illustrates a further aspect of the present disclosure, in particular, a plurality of ball wheel assemblies 12 mounted on an article of manufacture 50. The article of manufacture 50 may comprise, e.g., mechanics creepers, crates, carts, dollies, stretchers, gurneys, litters, beds, prams, transports, luggage, and other types of load carrying devices that require mobility. The plurality of ball wheel assemblies 12 may be mounted on an underside of the article of manufacture 50 to provide omni-directional rolling support. For example, the plurality of ball wheel assemblies 12 may be mounted on the underside of the article of manufacture 50 using permanent means of attachment (e.g., welds, adhesives, or integrally formed) or removable means of attachment (e.g., nuts, bolts, washers, screws, clips, nails, or tabs). While the plurality of ball wheel assemblies 12 is depicted in FIG. 9 as a set of four, it is contemplated by the present disclosure that sets ranging from approximately 2-100 may also be utilized depending on the size and carrying load intended for the article of manufacture 50. The plurality of ball wheel assemblies 12 allow the article of manufacture 50 to be adapted for use on uneven surfaces and overcoming obstacles/debris in the surrounding environment via the combination of the cushioning effect of the shock absorber 46 and the plurality of features 15 (e.g., balls 32 and raised knobs 16, or alternatively, the plurality of dimples 33) of the ball wheel 10.

Another aspect of the present disclosure is a method of using the ball wheel assembly 12 of FIGS. 6-9 on an article of manufacture 50. In particular, the method may comprise providing an article of manufacture 50 that requires omni-directional rolling support, such as a mechanics creeper, crate, cart, dolly, stretcher, gurney, litter, bed, pram, transport, luggage, or other types of load carrying devices that require mobility. The method may further include providing at least two ball wheel assemblies 12 of the present disclosure. The at least two ball wheel assemblies 12 may be incorporated into an underside of the article of manufacture 50 using permanent means of attachment (e.g., welds, adhesives, or integrally formed) or removable means of attachment (e.g., nuts, bolts, washers, screws, clips, nails, or tabs). In particular, a ball wheel assembly 12 may be incorporated into a corner of the underside of the article of manufacture 50 to provide optimal stability and maneuverability for the article of manufacture during use. The method may further include providing omni-directional rolling support to the article of manufacture via the at least two ball wheel assemblies 12. The at least two ball wheel assemblies 12 allow the article of manufacture 50 to be adapted for use on uneven surfaces and overcoming obstacles/debris in the surrounding environment via the combination of the cushioning effect of the shock absorber 46 and the plurality of features 15 (e.g., balls 32 and raised knobs 16, or alternatively, the plurality of dimples 33) of the ball wheel 10.

The ball wheel 10, assembly 12 and a method of use of the present disclosure are universally applicable to articles of manufacture 50 of all makes, models, sizes and manufacturers. Although the disclosure has been described and illustrated with respect to preferred aspects thereof, it is not to be so limited since changes, modifications, and combinations thereof may be made which are within the full intended scope of the disclosure.

What is claimed is:

1. A ball wheel for a ball wheel assembly, comprising:
a spherical shaped body having an exterior surface;
a plurality of features on the exterior surface of the body; and
the plurality of features configured to overcome obstacles, debris and uneven surfaces.

2. The ball wheel of claim 1, wherein the plurality of features comprise:
a plurality of raised knobs on the exterior surface of the body;
each knob of the plurality of raised knobs comprising a socket having an opening;
a ball inside the socket and extending through the opening; and
the ball and socket forming a ball-and-socket joint.

3. The ball wheel of claim 1, wherein the plurality of features comprise:
a plurality of dimples on the exterior surface of the body;
each dimple of the plurality of dimples comprising a bowl-shaped depression.

4. The ball wheel of claim 1, the spherical shaped body comprising rubber adapted to provide flexible rigidity to the ball wheel.

5. The ball wheel of claim 1, the plurality of features spaced equidistant apart on the exterior surface of the body.

6. The ball wheel of claim 2, the ball-and-socket joint configured to secure the ball inside the socket such that the ball does not rotate or fall out of the socket.

7. The ball wheel of claim 2, the ball formed of solid stainless steel or chrome steel.

8. The ball wheel of claim 1, the plurality of features integrally formed with the body.

9. The ball wheel of claim 2, each knob of the plurality of raised knobs comprising a uniform pyramidal shape having a circular base, a flat top and angled side walls.

10. The ball wheel of claim 3, wherein each dimple of the plurality of dimples comprise:
a circular bowl-shaped depression; or
a hexagonal bowl-shaped depression.

11. A ball wheel assembly, comprising:
a ball wheel, comprising:
a) a spherical shaped body having an exterior surface;
b) a plurality of features on the exterior surface of the body;
c) the plurality of features configured to overcome obstacles, debris and uneven surfaces;
a housing, comprising:
a) a socket having an opening;
b) the ball wheel inside the socket and extending through the opening;
c) the ball wheel rotatable inside the socket;
d) a retaining lip configured to retain the ball wheel inside the socket;
e) the ball wheel and socket forming a ball-and-socket joint; and
f) a shock absorber adapted to provide a cushioning effect to the ball wheel inside the socket of the housing;
the ball wheel assembly configured that the ball wheel may roll up and over obstacles/debris in the surrounding environment; and
the ball wheel assembly designed for use on uneven surfaces via the combination of the cushioning effect of the shock absorber and the plurality of features of the ball wheel.

12. The ball wheel assembly of claim 11, wherein the plurality of features comprise:
a plurality of raised knobs on the exterior surface of the body;
each knob of the plurality of raised knobs comprising a socket having an opening;
a ball inside the socket and extending through the opening; and
the ball and socket forming a ball-and-socket joint.

13. The ball wheel assembly of claim 11, wherein the plurality of features comprise:
a plurality of dimples on the exterior surface of the body; and
each dimple of the plurality of dimples comprising a circular bowl-shaped depression or a hexagonal bowl-shaped depression.

14. The ball wheel assembly of claim 11, the shock absorber configured to allow the ball wheel to vertically adjust inside the socket approximately ¼-1 inch as the ball wheel rolls over obstacles/debris or weight is applied to the housing.

15. The ball wheel assembly of claim 11, the shock absorber adapted to provide opposing forces to the ball wheel to maintain at least a portion of the ball wheel extending through the opening and outside the socket of the housing.

16. The ball wheel assembly of claim 11, the shock absorber comprising a coiled compression spring.

17. The ball wheel assembly of claim 11, wherein a plurality of ball wheel assemblies are mounted on an article of manufacture to provide omni-directional rolling support.

18. The ball wheel assembly of claim 17, wherein the article of manufacture may comprise mechanics creepers, crates, carts, dollies, stretchers, gurneys, litters, beds, prams, transports, or luggage.

19. A method of using a ball wheel assembly, comprising:
providing an article of manufacture that requires omni-directional rolling support;
providing at least two ball wheel assemblies;
incorporating the at least two ball wheel assemblies into the article of manufacture; and
providing omni-directional rolling support to the article of manufacture via the at least two ball wheel assemblies;
wherein the article of manufacture is adapted for use on uneven surfaces and overcoming obstacles/debris in the surrounding environment via the at least two ball wheel assemblies.

20. The method of claim 19, wherein each ball wheel assembly of the at least two ball wheel assemblies comprises:
a ball wheel, comprising:
a) a spherical shaped body having an exterior surface;
b) a plurality of features on the exterior surface of the body;
c) the plurality of features configured to overcome obstacles, debris and uneven surfaces;
d) wherein the plurality of features comprise:
a. a plurality of raised knobs on the exterior surface of the body, each knob of the plurality of raised knobs comprising a socket having an opening, a ball inside the socket and extending through the opening, and the ball and socket forming a ball-and-socket joint; or
b. a plurality of dimples on the exterior surface of the body, each dimple of the plurality of dimples comprising a circular bowl-shaped depression or a hexagonal bowl-shaped depression;
a housing, comprising:
a) a socket having an opening;
b) the ball wheel inside the socket and extending through the opening;
c) a retaining lip configured to retain the ball wheel inside the socket;
d) the ball wheel and socket forming a ball-and-socket joint; and
e) a shock absorber adapted to provide a cushioning effect to the ball wheel inside the socket of the housing;
the ball wheel assembly configured that the ball wheel may roll up and over obstacles/debris in the surrounding environment; and
the ball wheel assembly designed for use on uneven surfaces via the combination of the cushioning effect of the shock absorber and the plurality of features of the ball wheel.
